(19) United States
(12) Patent Application Publication
(10) Pub. No.: US 2025/0071211 A1
(43) Pub. Date: Feb. 27, 2025

(54) REPLACEABLE ARTIFICIAL INTELLIGENCE MODELS FOR VOICE AND TEXT CHANNELS

(71) Applicants: Slava Zhakov, Middletown, DE (US); Vyacheslav Sayko, Middletown, DE (US)

(72) Inventors: Slava Zhakov, Middletown, DE (US); Vyacheslav Sayko, Middletown, DE (US)

(21) Appl. No.: 18/797,385

(22) Filed: Aug. 7, 2024

Related U.S. Application Data
(60) Provisional application No. 63/578,762, filed on Aug. 25, 2023.

(51) Int. Cl. H04M 3/56; G06F 40/40; G10L 15/183; G10L 15/22; H04L 51/02; H04M 3/51; H04M 3/523

(52) U.S. Cl. CPC H04M 3/565; G06F 40/40; G10L 15/183; G10L 15/22; H04L 51/02; H04M 3/5183; H04M 3/5233

(57) ABSTRACT

A method for training AI models and interacting with customers during customer service sessions using one or more of the AI models is described. The method can be implemented on a cloud architecture where processing and storage resources used to support the AI models can be scaled based on demand. Customer interactions can be recorded and/or monitored in order to provide data for additional training for the AI models. In some embodiments, customer interactions are monitored in real-time in order to make decisions about whether to switch to an AI model more likely to provide a customer more accurate answers and/or a higher level of customer satisfaction.

### RELATED APPLICATIONS

This application claims priority to U.S. provisional patent application 63/578,762, entitled “ANALYZING CUSTOMER EXPERIENCE WITH REPLACEABLE ARTIFICIAL INTELLIGENCE MODELS FOR VOICE AND TEXT CHANNELS” and filed on Aug. 25, 2023, which is incorporated in its entirety and for all purposes.

### TECHNICAL FIELD

The embodiments discussed in the present disclosure are related to various configurations for creating a seamless customer service experience when transitioning between one or more artificial intelligence models and one or more customer service agents.

### BACKGROUND

Customer experience continues to increase in value and continues to be a differentiating factor that separates most successful businesses from the competition. Currently, customer experience quality validation is a manual process with little automation. Typically, an organization will survey a customer after a text or telephone interaction. This technique is rife with selection bias, imprecise metrics, and inaccurate self-appraisal by the subjects. Review of recorded or real-time customer interactions is likewise a difficult job, with many opportunities for subjective variations and mistakes by human reviewers. Consequently, making changes or updates to autonomous

What is needed is a validation and reporting system and process that comes with lower cost, broader coverage, higher scale, higher quality and new types of analytics in customer experience validation that can be automated, less subjective and less error prone.

### SUMMARY

Disclosed are various embodiments that relate to managing interaction between a customer service organization and its customers.

A method is disclosed and includes the following: receiving a first request from a customer during a customer service session; providing a first response to the first request generated by a first AI model; receiving a second request during the customer service session; determining whether a complexity of the second request exceeds a capability of the first AI model to respond; and in response to determining that the complexity of the second request exceeds the capability of the first AI model to respond, selecting a second AI model determined to be capable of responding to the second request, activating the second AI model, and providing a second response to the second request generated by the second AI model.

Another method is disclosed and includes the following: receiving a first request during a customer service session from a customer; providing a first response to the first request generated by a first AI model; determining whether the first response to the first request falls below a performance threshold; and in response to a determination that the first response to the first request falls below the performance threshold, activating a second AI model with more capability than the first AI model; receiving a second request during the customer service session; and providing a second response to the second request generated by the second AI model.

Other aspects and advantages of the described embodiments will become apparent from the following detailed description taken in conjunction with the accompanying drawings which illustrate, by way of example, the principles of the described embodiments.

### BRIEF DESCRIPTION OF THE DRAWINGS

Example embodiments will be described and explained with additional specificity and detail through the use of the accompanying drawings in which:

FIG. 1 illustrates schematically certain components that may be part of a system and method of the described embodiments;

FIG. 2 shows a block diagram indicating exemplary communications between a customer, a human customer service representative and one or more AI models of an AI model repository;

FIG. 3 shows a flow chart describing a method performed in accordance with the described embodiments; and

FIG. 4 shows a flow chart describing another method performed in accordance with the described embodiments.

### DETAILED DESCRIPTION

Customer experience continues to increase in value and continues to be an important differentiating factor that separates most successful businesses from the competition. In today's world, validation of the customer experience quality is typically performed manually with little automation. Human reviewers are error-prone, or subject to their own biases.

The disclosed embodiments relate to automated analysis, reporting of customer service experience and operation of customer service experiences with the help of interchangeable and tunable Artificial Intelligence Models. A system designed in accordance with the disclosed embodiments includes a set of services located in a cloud that perform speech to text conversion and text to speech conversion. The results of such conversion (e.g., text) may be input into generative AI (e.g., various versions of ChatGPT) in real time, or in batch. If in real time, the system may assist the customer service agent during phone and chat conversations, prompting specific words or sentences. If in batch, the system may analyze the transcripts and recordings of conversations, and produce a report based on the generative AI's assessment of the quality of the interaction. Human reviewers may still stay involved, whether continually or on an ad hoc basis, to provide tunability to the system.

For example, human reviewers may validate the validation reports themselves, giving feedback to the generative AI that will then become part of the model. A human feedback report might indicate, for example, that the validation report was completely wrong insofar as a customer left an interaction with a negative feeling about it but the AI report stated it was neutral or positive. Afterward, the model will grade similar interactions more accurately.

Models may be switched in and out. For example, if a generative AI having a first capability level does not seem capable in a certain context of accurate results, a generative AI having a second capability level greater than the first capability level might be substituted, or an organically grown model devised within the entity itself. The system thus includes an interface model that connects to a variety of available foundational Artificial Intelligence Models. The system allows tuning up foundational Artificial Intelligence (AI) Models specifically for the desired use cases thus targeting specific industry or customer. If built from scratch, original tuning of a system might occur upon predetermined scripts with known results (happy customers, frustrated customers, angry customers, etc.).

The system may include a service that is capable of learning new definitions of Key Performance Indicators (KPIs) based on the specific analysis tasks. For example, one set of KPIs might be happy/frustrated/angry-indications of customer emotions. A distinct set of KPIs might be loads/does not load shopping cart. Yet another might be lead generated/lead not generated. The system may include a predefined set of KPIs that are applicable for any customer experience quality analysis.

In use, the system may perform automated analysis of the customer interactions on the scale not possible before, enabling processing of the entire set of customer interactions versus small subset. Enterprise-wide performance evaluations may occur, or may alternately occur at any level of granularity (e.g., by individual call, by call center geography, by male versus female agent, etc.). The system may provide analytics on the entire set of customer interactions and enable types of analysis not possible before, such as allowing continuous and real time monitoring of KPIs and identified problems trends on all customer journeys, thus enabling continuous improvement of the Customer Experience.

The system and method of the disclosed embodiments includes a set of services that can be hosted on one or more cloud servers that performs: speech to text, text to speech conversion, making or monitoring phone and chat conversations, analyzing the transcripts and recordings of conversations, and producing a report.

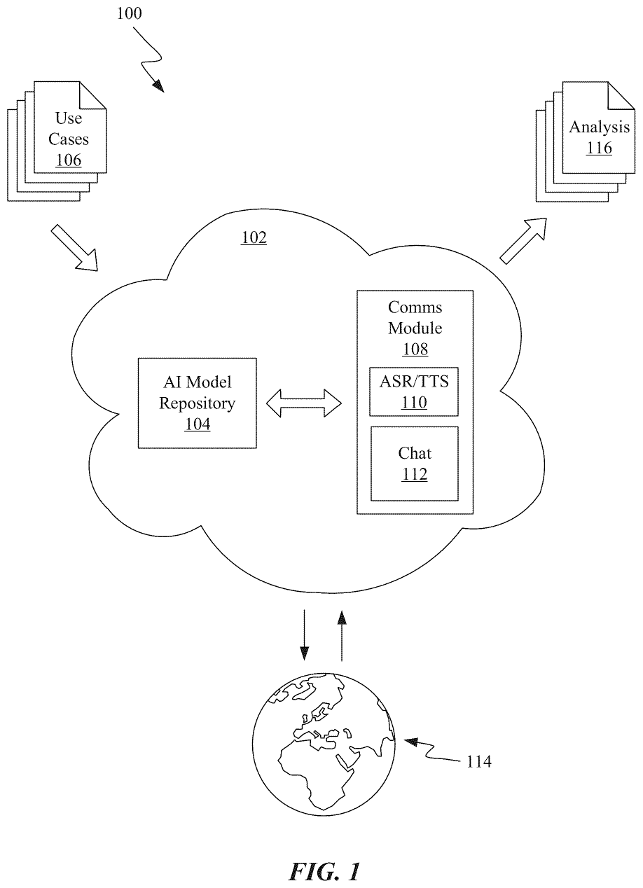

FIG. 1 illustrates schematically certain components that may be part of a system 100 and method of the described embodiments. Here, the system includes one or more cloud servers 102 running an AI model repository 104 that includes an interface model that may connect to a variety of available foundational Artificial Intelligence Models of or associated with AI model repository 104. System 100 allows tuning up one or more of the foundational Artificial Intelligence Models (organically within or for a particular enterprise) specifically for the desired use cases 106 thus targeting a specific industry or customer. Cloud server 102 can also include a communications module 108 that includes at least an ASR/TTS submodule 110 and chat submodule 112 for facilitating text and/or voice-based communication between AI models of AI model repository 104 and customers or testers of an AI-based or AI-supported customer service experience. As mentioned, this might occur via a set of already-evaluated training scripts based on use cases 106 that include multiple real world customer experience examples. After initial training, such models may be placed in the field or enterprise environment 108, and subject to additional feedback training by human reviewers. Then such models may be released to operate without constant or real time feedback/retraining.

The AI models discussed herein are large language model (LLM) based AI models capable of carrying on conversations with a customer at varying levels of complexity depending on the amount of training undergone by the AI model and depending on the amount of processing and informational resources allocated to the AI model.

The system may include a service that is capable of learning and/or generating analysis 114 that can include new or updated definitions of Key Performance Indicators based on the specific analysis tasks. For example, a KPI might focus on likely emotional state of a caller by the end of a customer experience session. Or, a KPI might focus on objective metrics, such as future profitability of a customer after the session is over. KPIs may be designed to address the particular needs of the entity for particular purposes, and may be interchanged in the presence of the same model, or may be interchanged with a different model. In this way, system 100 may also include a predefined set of Key Performance Indicators that are applicable for any customer experience quality analysis.

The system and method of the present invention may perform automated analysis of the customer interactions on the scale not possible before, enabling processing of the entire set of customer interactions versus small subsets. This could be enterprise-wide evaluations, demographic evaluations based on customer service agent, or demographic evaluations based on customers themselves. The system and method are equally fit for automated analysis of individual sessions, against specific KPIs.

The system and method may provide analysis 116 that includes analytics on the entire set of customer interactions and enables types of analysis not possible before, such as allowing to continuously monitor KPIs and identified problems trends on all customer journeys, thus enabling continuous improvement of the Customer Experience.

One exemplary embodiment of the system and method of the present invention may include: (1) an AI model connector; (2) an AI knowledge server; (3) a KPI definitions model; (4) a Text Analyzer; (5) a Speech-To-Text and Text-To-Speech model; (6) a Reporting System; and (7) an Agent Coaching Server.

Test cases (e.g., calibration scripts) may be inputs to the system. Based on the test cases, the system triggers the test case execution that is done by the text analyzer module that connects to AI connector and one or more AI models. Once trained, actual use cases become inputs, e.g., real time conversation text. The results of the AI model may be sent to the Reporting Module that produces the reports. A report may include, for example, a summary of the conversation, strengths and weaknesses, as well as KPI measurements, which themselves may be a standard set along with use case specific APIs that the system is capable of learning for a specific task.

As reflected above, the present invention may include a module for automated analysis and reporting of customer experience with the help of interchangeable and tunable Artificial Intelligence Models. A method as described above might include defining the test case, feeding it into the system, producing the reports, and creating a set of actions based on those reports summary, problems, strengths, and KPIs. Additionally, the principles of the present invention may be extended outside of customer experience field. It may, for example, be expanded to analysis of sales dialogues to evaluate sales performance and suggest optimization techniques.

The system and method may follow a client server model. For example, call center agents might work on headsets whose audio is input into a local client computer. ASR might occur locally, or the audio might be digitized and delivered to a cloud server for that purpose. The client operation may be on a web browser suitably programmed, or may be on a self-contained software application. Whether audio or text is initially input to the cloud server, the same or a different cloud server might function as the input/interface into the system, such as the AI model connector and/or the AI knowledge server. A monitoring/administrative station might similarly operate on a client connected to a cloud server. This station may be configured to permit switching of AI models as needed, and/or switching of KPIs.

The results of data analysis can be input either in real time or in batch to another AI model, the Agent Coaching Server. This optionally will produce personalized individual coaching recommendations for agents highlighting strengths, weaknesses, and personalized performance improvement recommendations. Like the other AI systems, this one may be trained and tuned in an analogous way, and may also have facilities for switching AI models for optimization.

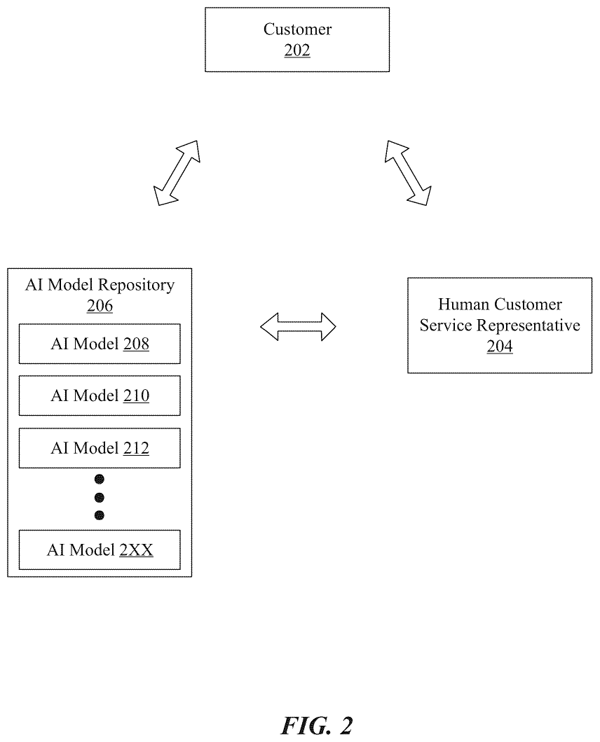

FIG. 2 shows a block diagram indicating exemplary communications between a customer 202, a human customer service representative 204 and one or more AI models of an AI model repository 206. In some embodiments, AI model repository 206 can be configured to run on a cloud service that allows for dynamic assignment of processing resources to help optimize an amount of processing resources applied to support a desired subset of AI models 208, 210, 212, 2XX to run at any given time.

In a first operating configuration, human customer service representative 204 can have primary responsibility for responding to customer 202. In this scenario, AI model repository 206 or processors associated with AI model repository 206 can be responsible for selecting an AI model 208 for monitoring interaction between customer 202 and human customer service representative 204. AI model 208 can be referred to or run in a coaching server configuration as AI model interaction occurs primarily between the AI model and human customer service representative 204 with minimal or no direct interaction with customer 202. In some embodiments, the monitoring can be used to generate reports geared toward improving performance of human customer service representative 204. In some embodiments, the selected AI model can also be used to prompt customer service representative 204 in real-time when the selected AI model is able to correlate the monitored customer interaction with one or more training examples that indicate a change in the customer interaction is warranted. For example, the selected AI model can be configured to identify subtle changes to a voice of customer 202 indicative of a change in emotion. Depending on the type of change in emotion (e.g. irritation, interest, anger or enthusiasm) the selected AI model of AI model repository 206 can communication recommendations to human customer service representative 204 for changes in discussion topic or various strategies to responding to customer 202 in a different way. In other embodiments, the change in emotions can take the form of a reduced customer service satisfaction score. In some embodiments, when the customer satisfaction score drops below a predetermined threshold value, such as, e.g. 70%, AI model 208 can recommend transfer of responsibility for the call to another human customer service representative or to transition the call to an AI model temporarily or for a duration of the call.

In a second configuration, human customer service representative 204 can share responsibility for responding to customer 202 with AI model repository 206. For example, AI model repository 206 can be configured to select AI model 208 for making initial contact with customer 202 and select a customer service representative 204 based on requests made during an initial conversation between AI model 208 and customer 202. In some embodiments, AI model 208 can be an AI model specifically configured to select customer service representative 204. Following selection of customer service representative 204, AI model 208 can continue to correspond with customer 202 to gather additional information about the customer service request(s) or transfer customer 202 directly over to the selected customer service representative 204. In some embodiments, AI model 208 can instead transfer customer 202 over to an intermediate AI model 210 in the event AI model 208 is primarily designed to identify an appropriate area of expertise needed by customer 202. In some embodiments, AI model 210 can be configured to handle issues more specifically tailored to the identified area of expertise identified for customer 202 by AI model 208. AI model 210 can then be configured to transfer customer 202 after gathering and passing on as many details as possible to human customer service representative 204 so that the conversation between customer 202 and human customer service representative 204 can be as efficient as possible.

For example, in the event customer 202 expressed an intention to close their account, a first AI model can be selected whereas a second AI model can be selected in the event customer 202 requested technical support. In some embodiments, the first AI model can be configured with a more comprehensive set of capabilities or processing resources than the second AI model as reasons for a customer closing their account can be more complex than troubleshooting a straightforward technical support issue. In the example of customer 202 expressing a desire to close their account, the second AI model can also be configured to identify a human customer service representative 204 most likely to be able to retain the customer's account. For example, there can be multiple human customer service representatives able to field a call regarding a customer wanting to be close their account. The first AI model can be designed to retrieve details about customer 202 and the issues customer 202 is facing prior to selecting an available customer service representative to discuss the account closure with customer 202. For example, one customer service representative can have a better performance history with customers from a particular geographical region and/or a performance history with customers experiencing specific types of issues with the company. The first AI model can also be configured to continue discussing the problem with customer 202 until a customer service representative with a greater likelihood of retaining the business of customer 202 is available to discuss identified issues with the customer.

In a third configuration, AI model repository 206 takes primary responsibility for communication with customer 202. Various AI models such as AI model 208, 210 and 212 can be used during a customer service session with customer 202. In this configuration, human customer service representative 204 can become involved only when a particular threshold is encountered. For example, an AI model 212 can be configured to provide reimbursements of up to $100. In some configurations, AI models of higher complexity can be authorized to provide higher reimbursements than AI models of lower complexity. Consequently, when customer 202 requests an accommodation exceeding the threshold, either human customer service representative 204 can be consulted for approval or a more complex AI model can be activated to authorize the accommodation exceeding the threshold.

The higher complexity AI or human customer service representative can be provided with a summary of the situation being faced by customer 202 in order to make an informed decision regarding providing the requested accommodation. The higher complexity AI can alternatively or additionally be configured to review an entirety of the customer service interaction prior to making a decision regarding authorizing the accommodation exceeding the threshold. In some embodiments, the human customer service representative can ask an AI model of AI model repository additional questions about the customer interaction prior to granting or denying the accommodation exceeding the threshold. The human customer service representative 204 can also opt to interact directly with customer 202 when additional details are needed to make a determination regarding making an accommodation exceeding the threshold.

In some embodiments, a threshold requiring a human customer service representative can be non-monetary in nature. For example, a catering business can allow for AI models of AI model repository 206 to handle booking of events expected to have fewer than a threshold number of guests, such as 50 or 100 guests. In the event the number of guests exceeds the threshold, human customer service representative 204 can be contacted to continue assisting customer 202 with booking an event. Generally the assigned AI model would pass any details already shared by customer 202 prior to transferring responsibility for the customer interaction to human customer service representative 204. In some embodiments, such as the one just provided where subject matter expertise is required, the human fielding the call might not be associated with the customer service hierarchy and the customer service interaction could end by promising a call back from an expert in the field or by scheduling an appointment with the expert in the event one is not currently available to handle the complexity of a particular task.

It should be appreciated that the customer interaction depicted between the customer 202, the AI model repository 206 and the human customer service representative 204 can be performed in a number of different ways. In the context of a chat conversation, the switches between AI models and human customer service representatives can happen with little to no visibility for the customer. In the event where the AI model needs approval or direction from a human customer service representative, the AI model can enter a post saying, “Let me ask for some help from my team.” At this point the human can provide an answer to help the AI model continue the interaction or the human customer service representative can take over the interaction after being filled in on the current state of affairs being faced by the customer. In the event that the AI model is waiting on an approval or denial from the human customer service representative, the AI model can instead of putting the customer on hold continue to converse with the customer asking if they have any other questions about the company or particular service at issue or engaging the customer with questions about their experience with past services and/or purchases.

In the context of the customer service session being performed as a voice conversation, an escalation to a human customer service representative can take the form of a conference call between the AI model, the customer and the human customer service representative in which the AI model is able to help transition the call to the human representative. For example, the AI model can start the conference call be summarizing the actions taken so far to the human customer service representative and then highlight any issues that have complicated arriving at a desired solution prior to leaving the conference call. An escalation between a first AI model, a second AI model and sometimes a third or fourth AI can occur with or without notifying the customer. Since the first and second AI models can have access to all records associated with the call, there is no need for a verbal transference of information.

In addition to the previously discussed reasons for switching between AI models, a need for a switch to another AI model can be triggered by real-time analysis indicating that responses to the customer are not meeting a performance threshold. Exemplary performance thresholds include a lack accuracy and/or a detected negative emotional response by the customer. For example, a monitoring AI model being powered by one or more processors can be configured to monitor voice or text conversations and rate the accuracy of each response provided to the customer. Following a threshold number of responses exceeding a pre-determined threshold number of incorrect or inaccurate responses, a new AI model can be assigned to take over responsibility for the interaction. In some embodiments, an answer can be identified as being incorrect when its accuracy is determined to be less than 80% or 90%. In addition to accuracy thresholds the customer service session can also be monitored for drops in customer satisfaction. In some embodiments, when the customer satisfaction falls below a threshold satisfaction of between 60% and 80%, a new AI model with increased capability is activated to assist with improving the customer satisfaction level.

In some embodiments, a customer's questions can be responded to by multiple different AI models without knowledge of the customer over the course of a customer service session. This can improve efficiency of the customer service engine where a customer session primarily includes questions capable of being responded to by a low-level AI and only includes one or two tougher questions that exceed the capabilities of the low-level AI. In such a customer service session, the AI model repository can be configured to activate a more advanced AI model only to respond to tougher questions and disable or assign the more complex AI model to other customer service sessions when the question complexity falls below a predetermined threshold level. In this way, the AI model repository can function with increased efficiency by only activating or requesting use of an activated high-level AI model that is more resource intensive \to address the tougher questions. For example, the lower-level AI can pause or state that it is looking up the desired information while the high-level AI is activated and readied to respond to the tougher question or series of questions.

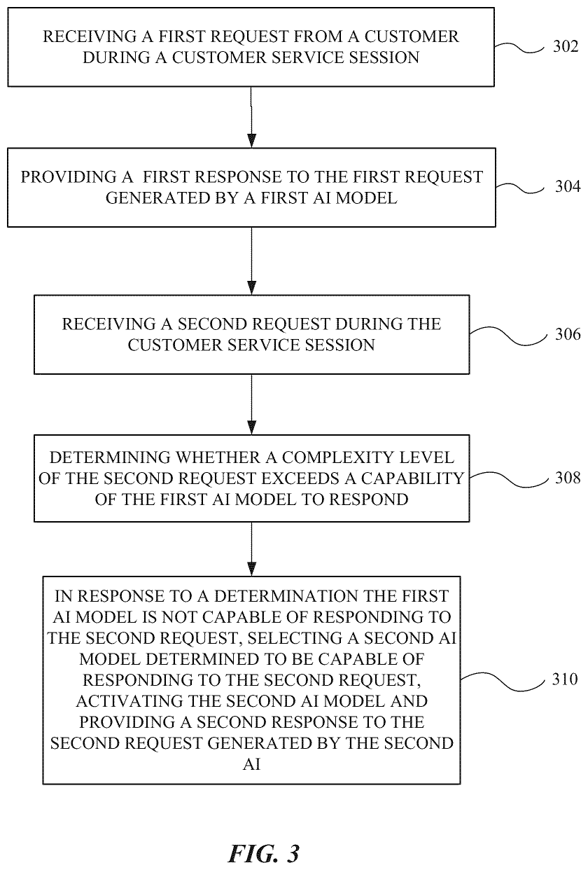

FIG. 3 shows a flow chart describing a method performed in accordance with the described embodiments. The method can be performed in a number of ways. In some embodiments, the AI models are responsible for both generating messages and providing the messages to the customer. In other embodiments, an AI model repository or AI connector is responsible for relaying the responses back and forth between the AI model and the customer. At 302, a first request is received during a customer service session. The request can be received via a mobile customer service application, via a text entry based website, via email or via an audio-based customer service interaction. At 304, a first AI model generates a first response to the first request and the first response is then provided to the customer. This first response can be part of an effort for the system to understand what problems or issues the customer is having. At 306, a second request is received during the same customer service session.

At 308, a determination is made as to whether the first AI model is capable of continuing to respond to the second request. In cases where the first and/or second requests make it clear what kind of assistance the customer is looking for, the determination can be that a more specialized AI model should be assigned to address the types of questions the customer will be asking going forward. In other embodiments, the second request made by the customer may be too abstract or generalized for the first AI model to respond to properly. In both cases, at 310, the more specialized or more advanced second AI is selected based on the information known about the customer's issue/problem. In embodiments where the second AI model is primarily activated to understand the problem that the customer is having, the method can involve returning to the first AI model or to a third AI model that is more specialized to deal with the specific types of issues the customer is experiencing. For example, the second AI model can be versed in all or at least most aspects of the business so that it has a higher likelihood of understanding the issue or issues being raised. The second AI model can also be configured to identify an AI model or human customer service representative well-versed in multiple aspects of the business in the event that a customer is having an issue or issues spanning multiple departments or categories of the business. By activating a higher resource cost, AI temporarily in this type of situation to address and identify the issues the customer is actually having, customer satisfaction can be improved and the time needed to address the customer's issue can be substantially reduced.

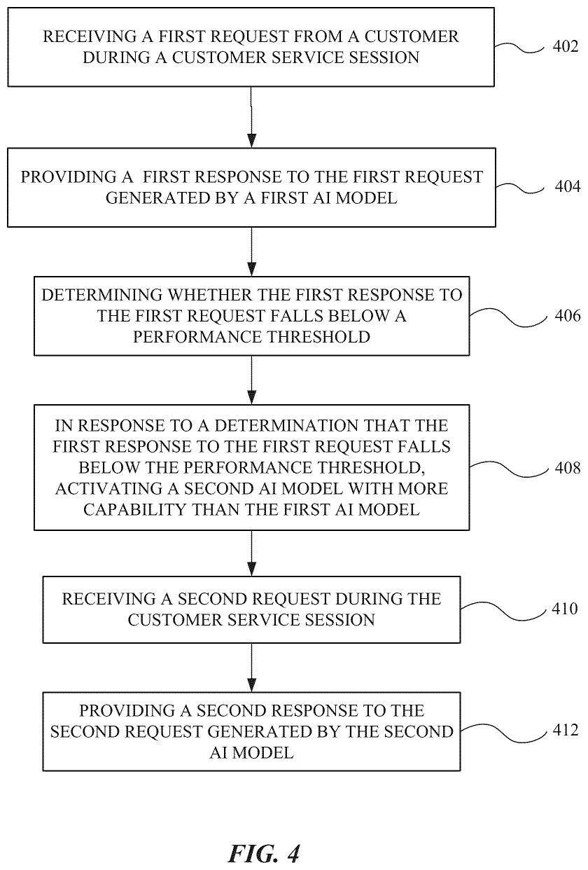

FIG. 4 shows a flow chart describing a method performed in accordance with the described embodiments. The method can be performed in a number of ways. In some embodiments, the AI models are responsible for both generating messages and providing the messages to the customer. In other embodiments, an AI model repository or AI connector is responsible for relaying the responses back and forth between the AI model and the customer. At 402, a first request is received during a customer service session. The request can be received via a mobile customer service application, via a text entry based website, via email or via an audio-based customer service interaction. At 404, a first AI model generates a first response to the first request and the first response is then provided to the customer. This first response can be part of an effort for the system to understand what problems or issues the customer is having.

At 406, a determination is made as to whether the first response to the first request falls below a performance threshold. Exemplary performance thresholds include a lack accuracy and/or a detected negative emotional response by the customer indicative of low customer service satisfaction levels. For example, a monitoring AI model being powered by one or more processors can be configured to monitor voice or text conversations and rate the accuracy of each response provided to the customer. In some embodiments, an answer can be identified as being incorrect when its accuracy is determined to be less than 80% or 90%.

At 408, in response to a determination that the first response to the first request falls below the performance threshold, a second AI model is activated with more capability and/or a skill set more aligned with the requests being made by the customer. It should be appreciated that in some embodiments, an AI model will only be replaced after a threshold number of incorrect or less accurate responses are generated. The number of incorrect or less accurate responses tolerated can vary based on how incorrect/inaccurate the responses are and/or how severely the inaccuracies affect the customer's level of satisfaction.

At 410 a second request is received during the customer service session and at 412 a second response to the second request is generated by the second AI model, which is in turn provided to the customer either directly by the AI model or by an intermediary service as is described above in greater detail.

It should be noted that the terminology of request and response is made in the text accompanying FIGS. 3 and 4 as well as in the claims. It should be appreciated that the term request is applied to communications from the customer and the term response is applied to communications from the AI model or customer service representative but it should be appreciated that a request from the customer may take the form of a response to something asked by the AI model and/or a response by the AI model can take the form of a question or request made by the AI model. For example, the AI model may request information from the customer to verify their identity or to provide more information about the issue or problem they are trying to have addressed during the customer service session.

Although the subject matter has been described in language specific to structural features and/or methodological acts, it is to be understood that the subject matter configured in the appended claims is not necessarily limited to the specific features or acts described above. Rather, the specific features and acts described above are disclosed as example forms of implementing the claims.

Unless specific arrangements described herein are mutually exclusive with one another, the various implementations described herein can be combined in whole or in part to enhance system functionality and/or to produce complementary functions. Likewise, aspects of the implementations may be implemented in standalone arrangements. Thus, the above description has been given by way of example only and modification in detail may be made within the scope of the present invention.

With respect to the use of substantially any plural or singular terms herein, those having skill in the art can translate from the plural to the singular or from the singular to the plural as is appropriate to the context or application. The various singular/plural permutations may be expressly set forth herein for sake of clarity. A reference to an element in the singular is not intended to mean “one and only one” unless specifically stated, but rather “one or more.” Moreover, nothing disclosed herein is intended to be dedicated to the public regardless of whether such disclosure is explicitly recited in the above description.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that include A alone, B alone, C alone, A and B together, A and C together, B and C together, or A, B, and C together, etc.). Also, a phrase presenting two or more alternative terms, whether in the description, claims, or drawings, should be understood to include one of the terms, either of the terms, or both terms. For example, the phrase “A or B” will be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements.

While preferred embodiments of the present invention have been shown and described herein, it will be obvious to those skilled in the art that such embodiments are provided by way of example only. Numerous variations, changes, and substitutions will now occur to those skilled in the art without departing from the scope of the invention. For example, the use of comprise, or variants such as comprises or comprising, includes a stated integer or group of integers but not the exclusion of any other integer or group of integers. It should be understood that various alternatives to the embodiments of the invention described herein may be employed in practicing the invention. It is intended that any claims presented at any time in this application define the scope of the invention and that methods and structures within the scope of these claims and their equivalents are covered thereby.

What is claimed is:

1. A method, comprising:
receiving a first request from a customer during a customer service session;
providing a first response to the first request generated by a first AI model;
receiving a second request during the customer service session;
determining whether a complexity of the second request exceeds a capability of the first AI model to respond; and
in response to determining that the complexity of the second request exceeds the capability of the first AI model to respond,
selecting a second AI model determined to be capable of responding to the second request,
activating the second AI model, and
providing a second response to the second request generated by the second AI model.

2. The method of claim 1, wherein the second AI model is selected based on the second request and previous requests and interactions made during the current customer service session and during previous customer service sessions with the customer.

3. The method of claim 1, further comprising:
receiving a third request during the customer service session;
determining that the third request needs approval by or discussion with a human customer service representative; and
initiating a conference call between the human customer service representative, the second AI model and a customer making the third request.

4. The method of claim 1, wherein the customer service session is a text-based customer service session occurring in one or more chat windows.

5. The method of claim 1, further comprising:
receiving a third request during the customer service session;
determining that the third request needs approval by a human customer service representative; and
requesting approval from the human customer service representative;
receiving a decision regarding the third request from the human customer service representative; and
providing a third response to the third request generated by the second AI model that is based on the decision received from the human customer service representative.

6. The method of claim 1, further comprising:
in response to determining the that the complexity of the second request does not exceed the capability of the first AI model to respond,
providing a second response to the second request generated by the first AI model.

7. The method of claim 1, wherein the first AI model and the second AI model are both large language model AI models.

8. The method of claim 1, further comprising:
receiving a third request during the customer service session;
determining that a complexity of the third request does not exceed a capability of the first AI model to respond; and
providing a third response to the third request generated by the second AI model that is based on the decision received from the human customer service representative.

9. A method, comprising:
receiving a first request during a customer service session from a customer;
providing a first response to the first request generated by a first AI model;
determining whether the first response to the first request falls below a performance threshold; and
in response to a determination that the first response to the first request falls below the performance threshold, activating a second AI model with more capability than the first AI model;
receiving a second request during the customer service session; and
providing a second response to the second request generated by the second AI model.

10. The method of claim 9, wherein the performance threshold is based on an accuracy of the first response to the first request.

11. The method of claim 10, wherein the performance threshold is also based on a detected customer service satisfaction level and accuracy of responses made before the first request.

12. The method of claim 9, wherein the customer service session is a voice-based session and transition between the first AI model and the second AI model is performed such that the transition from the first AI model to the second AI model is unnoticed by the customer.

13. The method of claim 9, further comprising:
receiving a third request during the customer service session;
determining that the third request needs approval by or discussion with a human customer service representative; and
selecting a human customer service representative from a list of available customer service representatives based on a compatibility between the customer and the human customer service representatives from the list of available customer service representatives.

14. The method of claim 13, wherein the compatibility between the customer and the human customer service representatives in the list of available customer service representatives is determined based on the customer service session and data from previous customer service sessions associated with the customer and with the available customer service representatives.

15. The method of claim 13, wherein the third request needs approval by or discussion with the human customer service representative when the third request meets a predetermined criteria for escalation to the human customer service representative.

16. The method of claim 13, further comprising:
initiating a conference call between the customer, the selected human customer service representative and the second AI model; and
providing a summary of the progress in the customer service session generated by the second AI model to the customer and the selected human customer service representative during the conference call.

17. The method of claim 9, wherein the predetermined criteria is a request to schedule an event for more than 50 guests.

18. The method of claim 9, further comprising:
receiving a third request during the customer service session;
determining that the third request needs approval by or discussion with a human customer service representative;
selecting a human customer service representative from a list of human customer service representatives based on a compatibility between the customer and the human customer service representatives from the list of human customer service representatives; and
scheduling a call with the selected customer service representative in response to the selected customer service representative being unavailable to speak immediately with the customer.

19. The method of claim 9, wherein the customer service session is a text-based customer service session occurring in one or more chat windows.

20. The method of claim 9, wherein the customer service session is a voice-based customer service session.
